(19) United States
(12) Patent Application Publication
(10) Pub. No.: US 2017/0160401 A1
(43) Pub. Date: Jun. 8, 2017

(54) Vehicle Navigation System Having Location Assistance from Neighboring Vehicles

(71) Applicant: Ford Global Technologies, LLC, Dearborn, MI (US)

(72) Inventor: Oliver Lei, Windsor (CA)

(21) Appl. No.: 14/959,413

(22) Filed: Dec. 4, 2015

(51) Int. Cl. G01S 19/51; G08G 1/0967; G01S 19/45; G01C 21/26

(52) U.S. Cl. CPC G01S 19/51; G01C 21/26; G08G 1/096791; G01S 19/45

(57) ABSTRACT

A navigation system for a host vehicle includes a transceiver and a controller. The transceiver is configured to communicate with a neighboring vehicle to obtain a location of the neighboring vehicle. The controller is configured to output navigation information including a location of the host vehicle based on the location of the neighboring vehicle, a distance between the vehicles based on duration of a communication between the transceiver and the neighboring vehicle, and a detected relative angle between the vehicles.

### TECHNICAL FIELD

The present disclosure relates to a navigation system of a host vehicle communicating with a neighboring vehicle to obtain information indicative of the location of the host vehicle.

### BACKGROUND

A navigation system of a vehicle uses the location of the vehicle in providing navigation functions. The navigation system communicates with, for example, a global navigation satellite system (GNSS) to obtain information indicative of the location of the vehicle. The navigation system uses this information to detect the location of the vehicle and uses the detected vehicle location in providing navigation functions.

Sometimes the navigation system may be unable to communicate with the GNSS to obtain information indicative of the location of the vehicle. Consequently, the navigation system is unable to detect the location of the vehicle. For instance, the navigation system may have a malfunctioned global positioning system (GPS) receiver unable to communicate with the GNSS; or the GPS receiver and the GNSS are unable to communicate with one another due to the vehicle being driven through a tunnel, an area with tall buildings, etc. In the latter cases, communication between the GPS receiver and the GNSS is prevented due to the tunnel or buildings or other obstruction attenuating or obstructing the communication signals.

### SUMMARY

A navigation system for a host vehicle includes a transceiver and a controller. The transceiver is configured to communicate with a neighboring vehicle to obtain a location of the neighboring vehicle. The controller is configured to output navigation information including a location of the host vehicle based on the location of the neighboring vehicle, a distance between the host vehicle and the neighboring vehicle based on duration of a communication between the transceiver and the neighboring vehicle, and a detected relative angle between the host vehicle and the neighboring vehicle.

The navigation system may further include a global positioning system (GPS) receiver configured to obtain information indicative of the location of the host vehicle from a remote source. The controller is further configured to control the transceiver to communicate with the neighboring vehicle to obtain the location of the neighboring vehicle while the GPS receiver is unable to obtain the information indicative of the location of the host vehicle from the remote source.

The transceiver may be further configured to communicate with a second neighboring vehicle to obtain a location of the second neighboring vehicle. In this case, the controller is further configured to output the location of the host vehicle further based on the location of the second neighboring vehicle.

The navigation system may further include a driver vehicle interface configured to receive the detected relative angle between the host vehicle and the neighboring vehicle from a user of the host vehicle.

The controller may be further configured to use a camera of the host vehicle to obtain the detected relative angle between the host vehicle and the neighboring vehicle.

A navigation method for a host vehicle includes communicating between the host vehicle and a neighboring vehicle for the neighboring vehicle to provide a location of the neighboring vehicle to the host vehicle. The method further includes detecting a distance between the host vehicle and the neighboring vehicle based on duration of a communication between the host vehicle and the neighboring vehicle and detecting a relative angle between the host vehicle and the neighboring vehicle. The method further includes outputting, on a navigation interface at the host vehicle, navigation information including a location of the host vehicle based on the location of the neighboring vehicle, the distance between the host vehicle and the neighboring vehicle, and the relative angle between the host vehicle and the neighboring vehicle.

Another navigation method for a host vehicle includes communicating between the host vehicle and a neighboring vehicle for the host vehicle to request the neighboring vehicle to provide a location of the neighboring vehicle to the host vehicle. This method further includes relaying the request of the host vehicle from the neighboring vehicle to a third vehicle to request the third vehicle to provide a location of the third vehicle to the neighboring vehicle, and relaying the location of the third vehicle from the neighboring vehicle to the host vehicle. This method further includes outputting, on a navigation interface at the host vehicle, navigation information including a location of the host vehicle based on the location of the third vehicle.

### BRIEF DESCRIPTION OF THE DRAWINGS

FIG. 1 illustrates a block diagram of a navigation system of a vehicle;

FIG. 2 illustrates a block diagram of the navigation system of a host vehicle communicating with a neighboring vehicle to obtain the location of the neighboring vehicle and to detect a distance between the host vehicle and the neighboring vehicle;

FIG. 3 illustrates a schematic diagram of the host vehicle and neighboring vehicles driving on the same portion of a road with the navigation system of the host vehicle communicating with one or more of the neighboring vehicles;

FIG. 4 illustrates a flowchart depicting operation of the navigation system of the host vehicle communicating with a neighboring vehicle to obtain the location of the neighboring vehicle and to detect the distance between the host vehicle and the neighboring vehicle for the navigation system to detect the host vehicle's location based on the location of the neighboring vehicle and the distance between the host vehicle and the neighboring vehicle;

FIG. 5A illustrates a schematic diagram of the host vehicle and a neighboring vehicle driving on a road with the navigation system of the host vehicle using a detected relative angle between the host vehicle and the neighboring vehicle in detecting the host vehicle's location; and

FIG. 5B illustrates a schematic diagram of geometry corresponding to the relative angle between the host vehicle and the neighboring vehicle.

### DETAILED DESCRIPTION

Detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

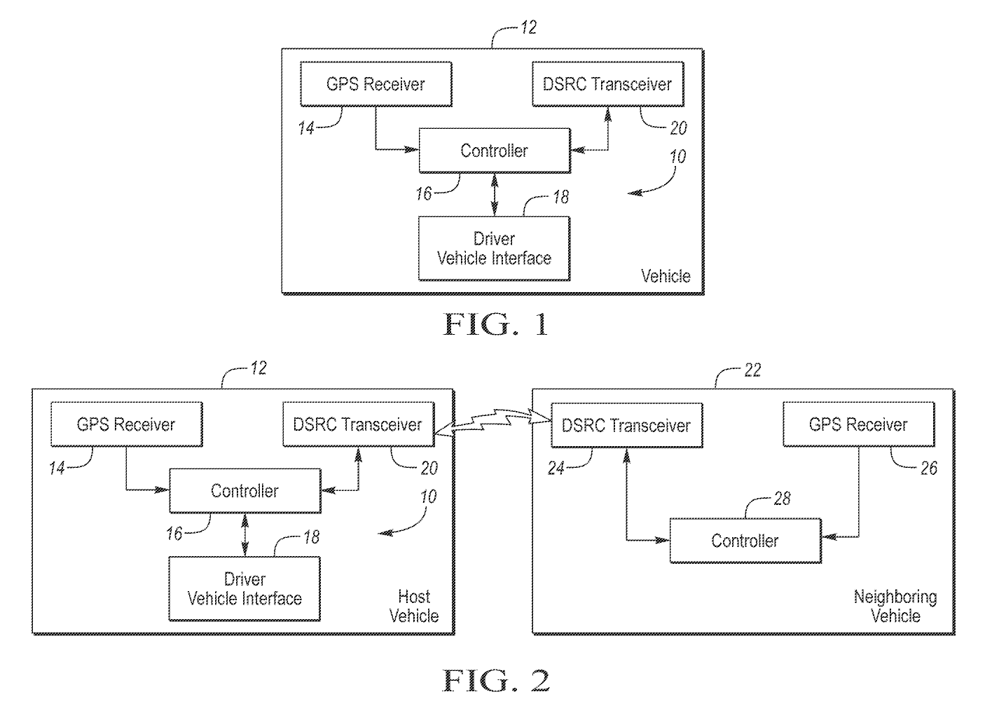

Referring now to FIG. 1, a block diagram of a navigation system 10 of a vehicle, such as a vehicle 12, is shown. Navigation system 10 includes a global positioning system (GPS) receiver 14, a controller 16, a driver vehicle interface 18, and a transceiver 20. Transceiver 20 is for vehicle-to-vehicle (V2V) communications. Transceiver 20 may employ Dedicated Short Range Communication (DSRC) technology. Transceiver 20 may be referred to herein as “DSRC transceiver” 20.

GPS receiver 14 communicates with a remote global navigation satellite system (GNSS) or the like to obtain information indicative of the location of vehicle 12 from the GNSS. Controller 16 detects the location of vehicle 12 from the information obtained by GPS receiver 14 indicative of the location of vehicle 12. Controller 16 generates navigation information based on the location of vehicle 12 and outputs the navigation information to driver vehicle interface 18. Driver vehicle interface 18 may include a display screen or the like which displays the location of vehicle 12 on a map for the driver to view. This process is ongoing so that driver vehicle interface 18 is updated as the location of vehicle 12 changes while the vehicle is being driven.

Transceiver 20 is able to communicate with corresponding V2V transceivers of vehicles which are located within the vicinity of vehicle 12. A vehicle is within the vicinity of vehicle 12 when, for example, both vehicles are driving along the same portion of a road. Vehicles within the vicinity of vehicle 12 may be referred to herein as “neighboring vehicles,” “remote vehicles,” or “neighboring (remote) vehicles.” Correspondingly, vehicle 12 may be referred to herein as “the vehicle” or the “host vehicle.”

DSRC transceiver 20 of vehicle 12 is able to communicate with the DSRC transceiver of a neighboring vehicle over a wireless vehicle communications network (e.g., a DSRC communications network). In this way, vehicle 12 is able to communicate with neighboring vehicles. Further, using DSRC communications, a neighboring vehicle within the vicinity of vehicle 12 may communicate with a third vehicle that is within the vicinity of the neighboring vehicle but is out of the vicinity of vehicle 12.

Sometimes GPS receiver 14 may be unable to communicate with the GNSS to obtain information indicative of the location of vehicle 12. For instance, GPS receiver 14 may be malfunctioned or may be unable to communicate with the GNSS due to vehicle 12 being driven through a tunnel or an area with tall buildings. GPS receiver 14 may be unable to communicate with the GNSS when the tunnel or buildings block the communication signals between GPS receiver 14 and the GNSS.

GPS receiver 14 does not provide controller 16 with information indicative of the location of vehicle 12 when the GPS receiver is unable to communicate with the GNSS. Consequently, without being provided with information indicative of the location of vehicle 12 from another source, controller 16 is unable to detect the location of vehicle 12. As a result, controller 16 is unable to output navigation information based on the location of vehicle 12 to driver vehicle interface 18.

Referring now to FIG. 2, with continual reference to FIG. 1, a block diagram of navigation system 10 of host vehicle 12 in communication with a neighboring vehicle 22 is shown. Navigation system 10 is able to communicate with neighboring vehicle 22 via a DSRC communications network. More descriptively, DSRC transceiver 20 of navigation system 10 and a DSRC transceiver 24 of neighboring vehicle 22 are able to communicate with one another.

As described above, controller 16 of navigation system 10 is unable to detect the location of host vehicle 12 using information from GPS receiver 14 when the GPS receiver is unable to obtain such information. A solution includes another source providing controller 16 with information indicative of the location of host vehicle 12.

In accordance with the present disclosure, navigation system 10 of host vehicle 12 communicates with one or more neighboring vehicles to obtain information indicative of the location of host vehicle 12. In particular, transceiver 20 of host vehicle 12 communicates with transceiver 24 of neighboring vehicle 22 to obtain the location of the neighboring vehicle. As neighboring vehicle 22 is within the vicinity of host vehicle 12, the location of the neighboring vehicle is generally indicative of the location of host vehicle 12. Further, the communication process itself (e.g., duration of time consumed for transmitting and receiving RF signals between transceiver 20 of host vehicle 12 and transceiver 24 of neighboring vehicle 22) is indicative of the distance between the host vehicle and the neighboring vehicle. The detected distance between host vehicle 12 and neighboring vehicle 24 in conjunction with the location of the neighboring vehicle is further indicative of the location of host vehicle 12.

Neighboring vehicle 22 includes its own navigation system having a GPS receiver 26 and a controller 28. GPS receiver 26 of neighboring vehicle 22 is able to communicate with the GNSS to obtain information indicative of the location of neighboring vehicle 22. For instance, GPS receiver 26 of neighboring vehicle 22 is not malfunctioned, neighboring vehicle 22 is not within a tunnel, tall buildings do not block communication signals with GPS receiver 26, etc. Controller 28 of neighboring vehicle 22 detects the location of neighboring vehicle 22 from the information obtained by GPS receiver 26 indicative of the location of neighboring vehicle 22.

Navigation system 10 of host vehicle 12 employs transceiver 20 to communicate with transceiver 24 of neighboring vehicle 22 when GPS receiver 14 is unable to provide information indicative of the location of host vehicle 12. The communications include transceiver 20 of host vehicle 12 (“host transceiver 20”) requesting transceiver 24 of neighboring vehicle 22 (“neighboring transceiver 24”) to transmit the location of neighboring vehicle 22 to host transceiver 20. Neighboring transceiver 24 responds by transmitting the location of neighboring vehicle 22 to host transceiver 20. Controller 16 receives the location of neighboring vehicle 22 from host transceiver 20. Controller 16 detects the general location of host vehicle 12 as being the obtained location of neighboring vehicle 22. Controller 16 detects the general location of host vehicle 12 being the location of neighboring vehicle 22 as the host vehicle and the neighboring vehicle are within the vicinity of one another. Controller 16 analyzes the communication signal transmission time between transceivers 20 and 24 to detect a distance between host vehicle 12 and neighboring vehicle 22. Controller 16 uses the detected distance to further specify the detected general location of host vehicle 12.

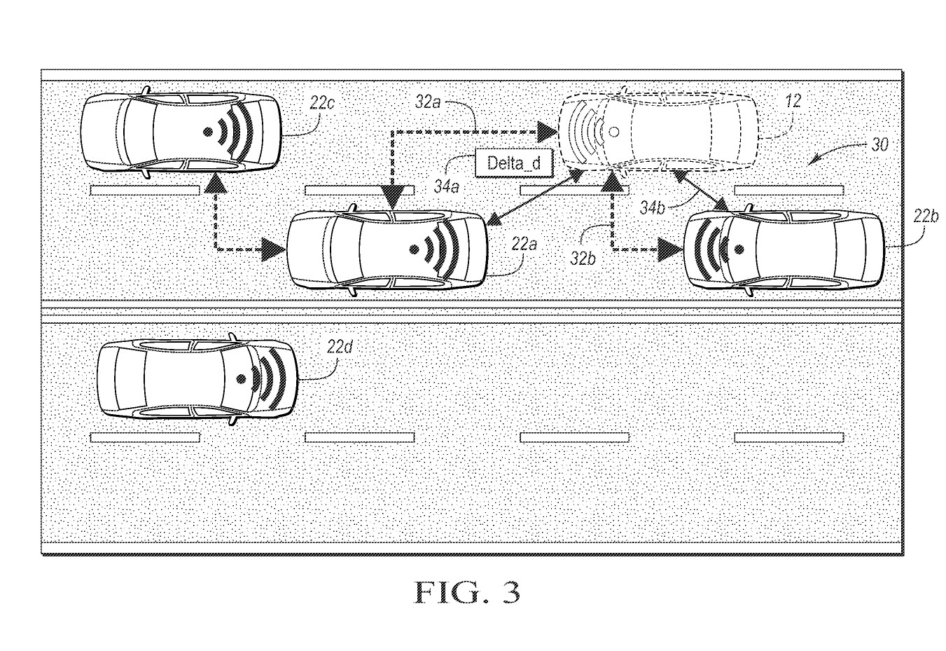

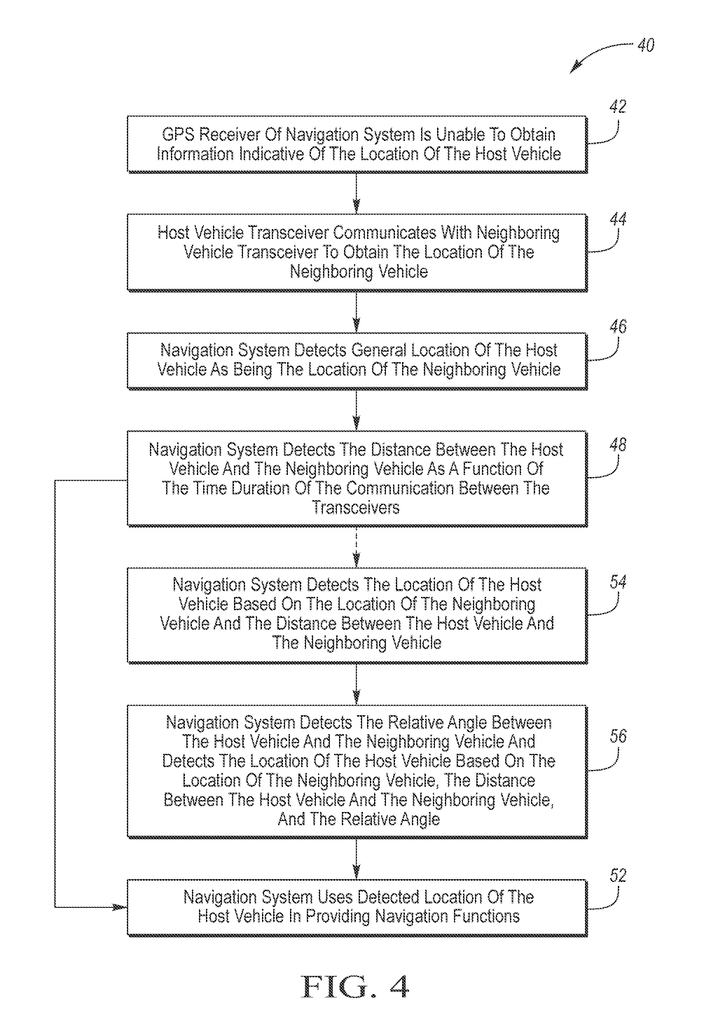

Referring now to FIGS. 3 and 4, with continual reference to FIGS. 1 and 2, the operation of navigation system 10 of host vehicle 12 in communicating with one or more neighboring vehicles 22 will be described in further detail. In this regard, FIG. 3 illustrates a schematic diagram of host vehicle 12 and neighboring vehicles 22a, 22b, 22c, and 22d driving on the same portion of a road 30 with navigation system 10 of host vehicle 12 communicating with one or more of the neighboring vehicles. FIG. 4 illustrates a flowchart 40 depicting the operation of navigation system 10 in communicating with one or more of the neighboring vehicles 22.

Navigation system 10 of host vehicle 12 initiates communication with one or more neighboring vehicles 22 when GPS receiver 14 of navigation system 10 is unable to obtain location information indicative of the location of host vehicle 12. The communication involves host transceiver 20 communicating with transceiver 24 of a neighboring vehicle 22 to obtain the location of the neighboring vehicle. Controller 16 of navigation system 10 is thus made aware that the general location of host vehicle 12 is the location of neighboring vehicle 22. Controller 16 analyzes the communications to detect a distance between host vehicle 12 and neighboring vehicle 22. As such, controller 16 detects the location of host vehicle 12 based on the location of neighboring vehicle 22 and the distance between the host vehicle and the neighboring vehicle.

In more detail, the operation commences when GPS receiver 14 of navigation system 10 is unable to obtain location information indicative of the location of host vehicle 12 during a given time period for whatever reason as indicated in block 42 of FIG. 4. In turn, controller 16 controls host transceiver 20 to communicate with one or more neighboring vehicles 22 to obtain the location of each of the one or more neighboring vehicles as indicated in block 44 of FIG. 4.

For instance, as shown in FIG. 3, host transceiver 20 communicates with the DSRC transceiver of first neighboring vehicle 22a via a first DSRC network path 32a and with the DSRC transceiver of second neighboring vehicle 22b via a second DSRC network path 32b. The communications include host transceiver 20 requesting from first neighboring vehicle 22a the location of the first neighboring vehicle and the DSRC transceiver of the first neighboring vehicle transmitting the location of the first neighboring vehicle to host transceiver 20. Likewise, the communications include host transceiver 20 requesting from second neighboring vehicle 22b the location of the second neighboring vehicle and the DSRC transceiver of the second neighboring vehicle transmitting the location of the second neighboring vehicle to host transceiver 20.

As shown in FIG. 3, host vehicle 12 and neighboring vehicles 22a, 22b, and 22c are traveling in the same direction on road 30 whereas neighboring vehicle 22d is traveling in the opposite direction on the road. Preferably, host transceiver 20 communicates with neighboring vehicles 22 traveling in the same direction with host vehicle 12 to obtain the locations of these neighboring vehicles. Neighboring vehicles 22 traveling in the same direction as host vehicle 12 can provide continuous location data.

Controller 16 of navigation system 10 receives from host transceiver 20 the location of a neighboring vehicle 22 and detects the general location of host vehicle 12 as being the location of the neighboring vehicle as indicated in block 46 of FIG. 4. For instance, in the example in which host transceiver 20 obtains the locations of first and second neighboring vehicles 22a and 22b, controller 16 uses the locations of the first and second neighboring vehicles in conjunction with one another to improve the accuracy of the detected location of host vehicle 12. As such, host transceiver 20 can communicate with multiple neighboring vehicles 22 to improve the accuracy of the detected location of host vehicle 12.

Further, the neighboring vehicles are dynamic. If a neighboring vehicle no longer stays with host vehicle 12 on the route, then DSRC transceiver 20 can communicate with other neighboring vehicles.

Controller 16 of navigation system 10 detects the distance between host vehicle 12 and a neighboring vehicle 22 (e.g., distance “Delta_d” 34a between host vehicle 12 and neighboring vehicle 22a in FIG. 3) based on the time duration of communication between host transceiver 20 and the transceiver of the neighboring vehicle as indicated in block 48 of FIG. 4.

For instance, controller 16 detects the distance between host vehicle 12 and neighboring vehicle 22 via DSRC technology. For example, for a DSRC module implementing a TCP/IP stack, a method could be follows: host transceiver 20 sends a “ping” to transceiver 24 of neighboring vehicle 22; host transceiver 20 receives “reply” of the ping from neighboring transceiver 24; and controller 16 calculates the round-trip time of “ping”-“reply”, which is indicative of the distance between host vehicle 12 and neighboring vehicle 22. For example, assume the message processing time in a DSRC transceiver is fixed as T_process. The round-trip time (T_rtt) is then equal to 2*(T_process+signal_travel_time between vehicles 12 and 22). The signal_travel_time between vehicles 12 and 22 follows the equation: c=2*Delta_d/T_rtt, where c≈300000 km/s (the speed of light). Another method uses an ultrasonic sensor to measure the distance between vehicles 12 and 22.

Controller 16 likewise detects the distances between host vehicle 12 and other neighboring vehicles 22 (e.g., distance 34b between host vehicle 12 and second neighboring vehicle 22b) in communication with navigation system 10.

Controller 16 detects the location of host vehicle 12 based on the obtained location of a neighboring vehicle 22 and the detected distance between host vehicle 12 and the neighboring vehicle as indicated in block 50 of FIG. 4. For instance, in the example in which host transceiver 20 obtains the locations of first and second neighboring vehicles 22a and 22b and detects distances between host vehicle 12 and each of the first and second neighboring vehicles, controller 16 uses the obtained locations and the detected distances in conjunction with one another to further improve the accuracy of the detected location of host vehicle 12.

Controller 16 uses the detected location of host vehicle 12 in providing navigation information to driver vehicle interface 18 as indicated in block 52 of FIG. 4. Alternately, controller 16 may use the detected general location of host vehicle 12 (detected in block 46 of FIG. 4) in providing navigation information to driver vehicle interface 18 when the distance between host vehicle 12 and neighboring vehicle 22 is relatively small.

Referring further to FIG. 3, a neighboring vehicle 22 within the vicinity of host vehicle 12 may communicate with a third vehicle that is within the vicinity of the neighboring vehicle, but it not within the vicinity of host vehicle 12. In this case, the third vehicle is a neighboring vehicle to neighboring vehicle 22, but is not a neighboring vehicle to host vehicle 12. For illustration, assume that the third vehicle is third vehicle 22c shown in FIG. 3. Third vehicle 22c is therefore considered to be within the vicinity of first neighboring vehicle 22a, but is not considered to be within the vicinity of host vehicle 12. Accordingly, navigation system 10 of host vehicle 12 does not communicate directly with third vehicle 22c.

However, first neighboring vehicle 22a can communicate directly with third vehicle 22c and may therefore relay a location request from host vehicle 12 to the third vehicle. Such capability may be employed when the GPS receivers of both host vehicle 12 and first neighboring vehicle 22a are unable to obtain information indicative of the locations of their respective vehicles. This may occur when both host vehicle 12 and first neighboring vehicle 22a are in a tunnel or an area with tall buildings. On the other hand, third vehicle 22c is farther down road 30 and therefore is out of the tunnel or the area with tall buildings. Accordingly, the GPS receiver of third vehicle 22c is able to obtain information indicative of the location of the third vehicle.

In operation, navigation system 10 of host vehicle 12 transmits a location request to first neighboring vehicle 22a which relays the request to third vehicle 22c. Third vehicle 22c responds to the request by transmitting its location to first neighboring vehicle 22a which in turn relays the location of third vehicle 22c to navigation system 10. The communication signal relayed from first neighboring vehicle 22a to host transceiver 20 may include information indicating that the location request was relayed to third vehicle 22c or the like. Controller 16 of navigation system 10 receives from host transceiver 20 the location of third vehicle 22c and detects the general location of host vehicle 12 as being the location of the third vehicle.

In this way, for instance, if host vehicle 12 and neighboring vehicles are all in a tunnel, then the location request may be relayed by the neighboring vehicles to eventually reach a vehicle located outside of the tunnel. Further, the relaying may include relaying between multiple vehicles in a sequential fashion or the like (e.g., between a neighboring vehicle of host vehicle 12 and one or more other vehicles which are not within the vicinity of host vehicle 12) until a vehicle having an operable GPS receiver responds with its location.

Thus, when host vehicle 12 and other vehicles are in a tunnel, host vehicle 12 may not be able to obtain the location data directly from its immediate neighboring vehicles 22. Immediate neighboring vehicles 22 may request the data from their immediate neighboring vehicles, who in turn may request the data from their immediate neighbors. Eventually, the location data can be obtained from a vehicle at the exit (or entrance) of the tunnel.

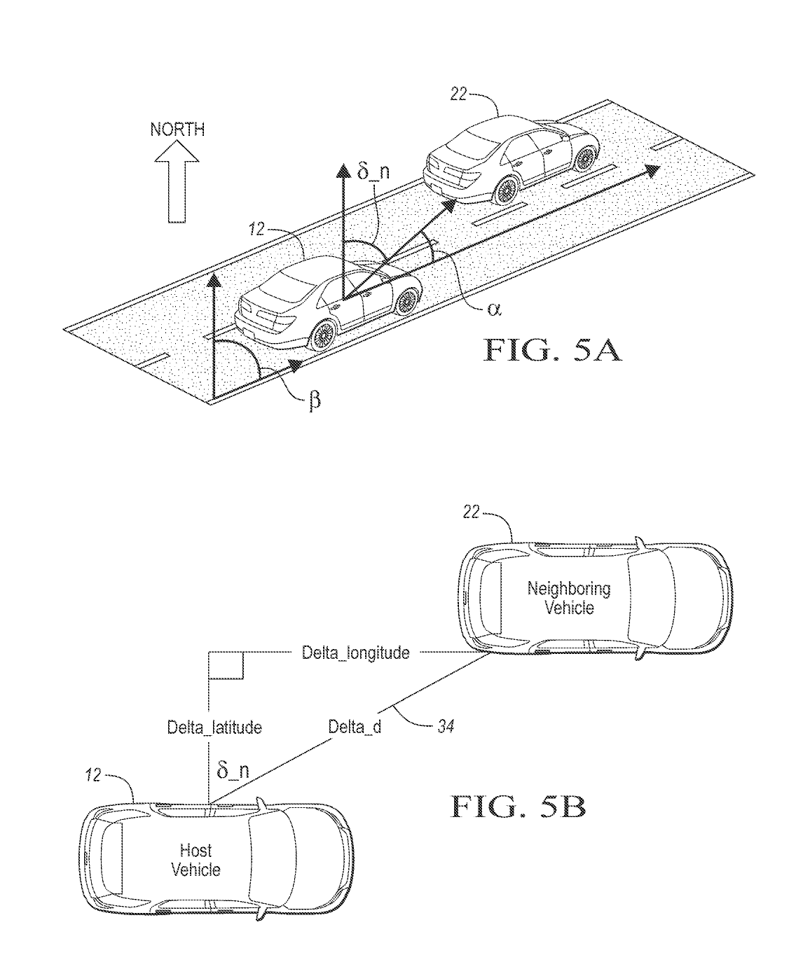

Referring now to FIGS. 5A and 5B, with continual reference to FIGS. 1, 2, 3, and 4, operation of navigation system 10 of host vehicle 12 using a detected relative angle between host vehicle 12 and a neighboring vehicle 22 in detecting the location of the host vehicle will be described. In this regard, FIG. 5A illustrates a schematic diagram of host vehicle 12 and neighboring vehicle 22 driving on a road with navigation system 10 using a detected relative angle α between host vehicle 12 and neighboring vehicle 22 in detecting the location of host vehicle 12. FIG. 5B illustrates a schematic diagram of geometry corresponding to the relative angle α between host vehicle 12 and neighboring vehicle 22.

The operation of navigation system 10 using detected relative angle α between host vehicle 12 and a neighboring vehicle 22 in detecting the location of host vehicle 12 follows the operation of navigation system 10 in obtaining the location of neighboring vehicle 22 and detecting a distance 34 between host vehicle 12 and neighboring vehicle 22. As described herein, host transceiver 20 communicates with neighboring vehicle 22 for the neighboring vehicle to provide its location to navigation system 10 of host vehicle 12 and controller 16 of navigation system 10 analyzes the communication duration to detect distance 34 between host vehicle 12 and the neighboring vehicle. As such, controller 16 detects the location of host vehicle 12 based on the location of neighboring vehicle 22 and the distance between the host vehicle and the neighboring vehicle.

Controller 16 further refines the detected location of host vehicle 12 using relative angle α between host vehicle 12 and neighboring vehicle 22. In operation, controller 16 uses the exterior cameras or the like of host vehicle 12 to detect relative angle α between host vehicle 12 and neighboring vehicle 22 (indicated in block 54 of FIG. 4). The driver of host vehicle 12 may manually input relative angle α to controller 16 via driver vehicle interface 18. Controller 16 calculates the absolute angle of host vehicle 12 to neighboring vehicle 22 facing North direction δ_n=β−α. Controller 16 then calculates distance (Delta_d) 34 (in meters) to North and East using the following equations:

Delta_longitude=sine(δ_n)*Delta_d

Delta_latitude=cosine(δ_n)*Delta_d

Controller 16 therefore detects a more accurate location of host vehicle 12 based on the location of neighboring vehicle, the detected distance 34 between host vehicle 12 and neighboring vehicle 22, and the Delta_longitude and Delta_latitude components (indicated in block 56 of FIG. 4). Controller 16 uses the Delta_longitude and Delta_lattitude components to calculate the location of host vehicle 12 in coordinates decimal degrees.

The description regarding FIGS. 5A and 5B is obviously just one example. The road direction could be in any other direction. The calculations for other road directions would be done in similar fashion as described with regards to FIGS. 5A and 5B.

Controller 16 continues to calculate the location data (i.e., the latitude and longitude) of host vehicle 12 using the location of neighboring vehicle, the detected distance 34 between host vehicle 12 and neighboring vehicle 22, and the Delta_longitude and Delta_latitude components in accordance with the following algorithm.

//Earth's spherical mean radius,

R=6371009

//Host vehicle coordinate offsets in radians

dLat=Delta_latitude/R

dLon=Delta_longtitude/(R*Cosine(Pi*Neighboring_vehicle_latitude/180))

//Host vehicle position data in decimal degrees

Host_vehicle_latitude=Neighboring_vehicle_latitude+dLat*180/Pi

Host_vehicle_longitude=Neighboring_vehicle_longitude+dLon*180/Pi

Controller 16 uses this more accurate detected location of host vehicle 12 in providing navigation information to driver vehicle interface 18.

If host vehicle 12 and neighboring vehicles are all in a tunnel, then the neighboring vehicle next to a vehicle located outside of the tunnel can calculate the location data similarly and then relay its calculated location data to its next neighboring vehicle in the tunnel. Its next neighboring vehicle then calculates its location data and relays to its neighboring vehicle behind. In this fashion, host vehicle 12 can eventually obtain the location data of its neighboring vehicle just in front of it, and calculate its location data.

While exemplary embodiments are described above, it is not intended that these embodiments describe all possible forms of the present invention. Rather, the words used in the specification are words of description rather than limitation, and it is understood that various changes may be made without departing from the spirit and scope of the invention. Additionally, the features of various implementing embodiments may be combined to form further embodiments of the present invention.

What is claimed is:

1. A navigation system for a host vehicle comprising:
a transceiver configured to communicate with a neighboring vehicle to obtain a location of the neighboring vehicle; and
a controller configured to output navigation information including a location of the host vehicle based on the location of the neighboring vehicle, a distance between the vehicles based on duration of a communication between the transceiver and the neighboring vehicle, and a detected relative angle between the vehicles.

2. The navigation system of claim 1 wherein:
the transceiver is a dedicated short range communication transceiver.

3. The navigation system of claim 1 further comprising:
a global positioning system (GPS) receiver configured to obtain information indicative of the location of the host vehicle from a remote source; and
wherein the controller is further configured to control the transceiver to communicate with the neighboring vehicle to obtain the location of the neighboring vehicle while the GPS receiver is unable to obtain the information indicative of the location of the host vehicle from the remote source.

4. The navigation system of claim 1 wherein:
the transceiver is further configured to communicate with a second neighboring vehicle to obtain a location of the second neighboring vehicle; and
the controller is further configured to output the location of the host vehicle further based on the location of the second neighboring vehicle.

5. The navigation system of claim 1 further comprising:
a driver vehicle interface configured to receive the detected relative angle from a user of the host vehicle.

6. The navigation system of claim 1 wherein:
the controller is further configured to use a camera of the host vehicle to obtain the detected relative angle.

7. A navigation method for a host vehicle comprising:
communicating between the host vehicle and a neighboring vehicle for the neighboring vehicle to provide a location of the neighboring vehicle to the host vehicle;
detecting a distance between the host vehicle and the neighboring vehicle based on duration of a communication between the host vehicle and the neighboring vehicle;
detecting a relative angle between the host vehicle and the neighboring vehicle; and
outputting, on a navigation interface at the host vehicle, navigation information including a location of the host vehicle based on the location of the neighboring vehicle, the distance between the host vehicle and the neighboring vehicle, and the relative angle between the host vehicle and the neighboring vehicle.

8. The navigation method of claim 7 wherein:
the communicating between the vehicles includes using dedicated short range communication technology.

9. The navigation method of claim 7 further comprising:
attempting to obtain information indicative of the location of the host vehicle from a remote source; and
wherein the communicating is performed while the information indicative of the location of the host vehicle is unable to be obtained from the remote source.

10. The navigation method of claim 7 further comprising:
communicating between the host vehicle and a second neighboring vehicle for the second neighboring vehicle to provide a location of the second neighboring vehicle to the host vehicle; and
wherein the location of the host vehicle is further based on the location of the second neighboring vehicle.

11. The navigation method of claim 7 wherein:
the detecting the relative angle includes receiving the relative angle from a user of the host vehicle.

12. The navigation method of claim 7 wherein:
the detecting the relative angle includes using a camera of the host vehicle to obtain the relative angle.

13. The navigation method of claim 7 wherein:
the distance between the host vehicle and the neighboring vehicle is detected based on duration of a radio-frequency wireless communication between the host vehicle and the neighboring vehicle.

14. The navigation method of claim 7 wherein:
the distance between the host vehicle and the neighboring vehicle is detected based on duration of an ultrasonic communication between the host vehicle and the neighboring vehicle.

15. A navigation method for a host vehicle comprising:
communicating between the host vehicle and a neighboring vehicle for the host vehicle to request the neighboring vehicle to provide a location of the neighboring vehicle to the host vehicle;
relaying the request of the host vehicle from the neighboring vehicle to a third vehicle to request the third vehicle to provide a location of the third vehicle to the neighboring vehicle, and relaying the location of the third vehicle from the neighboring vehicle to the host vehicle; and
outputting, on a navigation interface at the host vehicle, navigation information including a location of the host vehicle based on the location of the third vehicle.

16. The navigation method of claim 15 wherein:
the communicating between the vehicles includes using Dedicated Short Range Communication technology.

17. The navigation method of claim 15 further comprising:
attempting to obtain information indicative of the location of the host vehicle from a remote source; and
wherein the communicating is performed while the information indicative of the location of the host vehicle is unable to be obtained from the remote source.
